(19) United States
(12) Patent Application Publication
(10) Pub. No.: US 2010/0268582 A1
(43) Pub. Date: Oct. 21, 2010

(54) AFFILIATE SYSTEM ON SOCIAL NETWORKING

(75) Inventor: Yoshinori TANAKA, Yokohama-shi (JP)

Correspondence Address: MORGAN & FINNEGAN LLP Transition Team;c/o Locke Lord Bissell & Liddell, 3 WORLD FINANCIAL CENTER, NEW YORK, NY, 10281-2101, US

(73) Assignee: INTERNATIONAL BUSINESS MACHINES CORPORATION, Armonk, NY (US)

(21) Appl. No.: 12/426,857

(22) Filed: Apr. 20, 2009

(51) Int. Cl. G06Q 99/00; G06Q 30/00

(52) U.S. Cl. 705/14.4; 705/14.66; 705/319; 705/14.45

(57) ABSTRACT

An affiliate system on social networking is disclosed and includes a method by which advertisement data of a user may be automatically associated with the advertisement data of other users based upon the users' respective blog data. In one embodiment, a contribution score of a user may be determined based upon the user's posting, in a blog, of advertisements affiliated with other users. The advertisements on a user's blog may be displayed based upon the contribution scores of other users. If an advertisement affiliated with another user is viewed, the user who posted that advertisement may receive a contribution credit.

### FIELD

The embodiments disclosed herein relate to an affiliate system on social networking.

### BACKGROUND

Users of a social network can actively communicate with one another via the internet by posting blog information. However, existing social networks are inadequate in some respects, such as by (1) failing to provide adequate incentives for users to initially join or to continue to participate, and (2) being incapable of coordinating inter-user advertisement affiliations. As a result, existing social networks do not provide users with their expected benefits, and advertising efforts within existing social networks either fail or are inefficient.

### SUMMARY

A method is disclosed in various embodiments by which advertisement data can be associated with a user of a social network based upon the user's blog data. The method may also apply to multiple users. The disclosed embodiments are advantageous by, for example, enhancing incentives to participate in a social network, improving synergistic effects based upon the mutual use of affiliated advertisements among users, and fostering new connections in the network.

In one embodiment, a method can have a number of steps comprising, but not limited to, those following herein. The method may begin by providing, through a server, a social network service. The method may continue by providing a first user and a second user of the social network service, the first user and the second user each having a blog. The method may continue by providing first user blog data of first user's blog, and first user advertisement data of first user's affiliated advertisements. The method may continue by providing second user blog data of second user's blog, and second user advertisement data of second user's affiliated advertisements. The method may continue by searching for target data in the first user blog data. The method may continue by determining whether the first user blog data includes the target data. The method may continue, if the first user blog data includes the target data, by determining whether the second user data includes the target data. The method may continue, if the second user blog data includes the target data, by automatically associating the second user advertisement data with the first user advertisement data. The method may continue by determining a contribution score of a user of the social network service based upon the user's posting, in a blog, of advertisements affiliated with other users of the social network service. The method may continue by assigning a display priority to the first user advertisement data based at least in part upon second user's contribution score. The method may continue by displaying advertisements on first user's blog in accordance with the display priority. The method may continue by recording a viewing event of an advertisement on first user's blog. The method may continue by providing a contribution credit to the first user if the viewed advertisement is affiliated with another user.

### DESCRIPTION OF THE FIGURES

FIG. 1 discloses examples of hardware and software resources that may be utilized when implementing various example embodiments.

FIG. 2 is an example flow diagram of an example embodiment of a sequence of steps carried out by the system of FIG. 1.

FIG. 3 discloses an exemplary social network.

FIG. 4 discloses an exemplary blog page structure.

### DISCUSSION OF EXAMPLE EMBODIMENTS

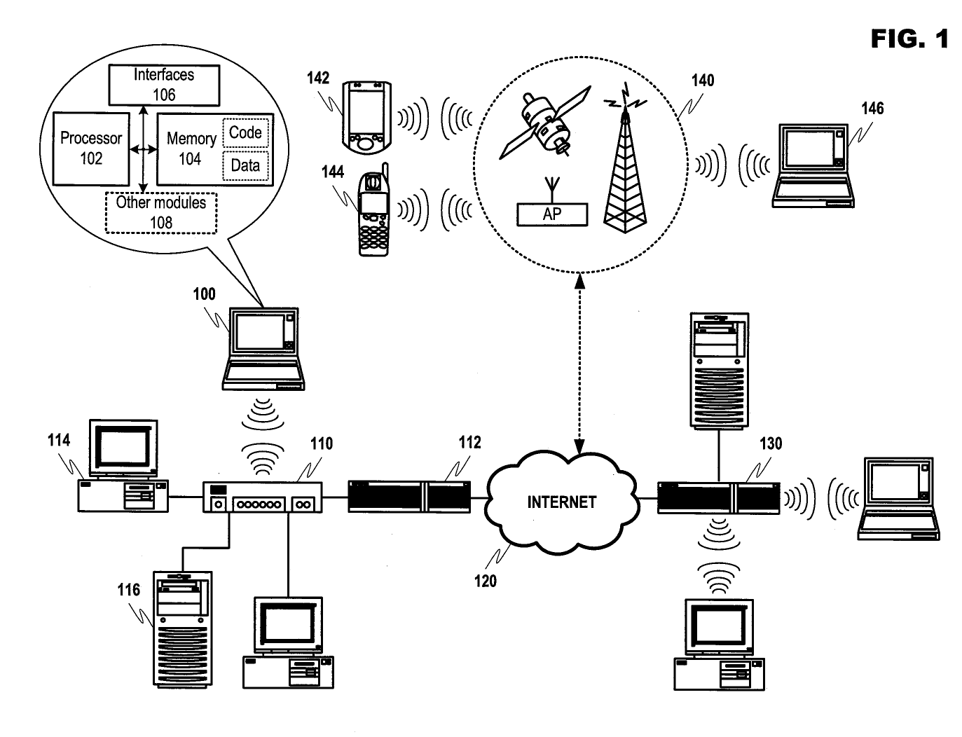

An example of a system that is usable for implementing various embodiments of the present invention is disclosed in FIG. 1. The system comprises elements that may be included in, or omitted from, configurations depending, for example, on the requirements of a particular application, and therefore, is not intended to limit the embodiments in any manner.

Computing device 100 may be, for example, a laptop computer. Elements that represent basic example components comprising functional elements in computing device 100 are disclosed at 102-108. Processor 102 may include one or more devices configured to execute instructions, wherein a group of instructions may be constituted, for example, as program code. In at least one scenario, the execution of program code may include receiving input information from other elements in computing device 100 in order to formulate an output (e.g., data, event, activity, etc). Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 104 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus-to-user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 100 may provide wired and/or wireless support to devices such as computer 114 and server 116. Hub 100 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130, no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication.

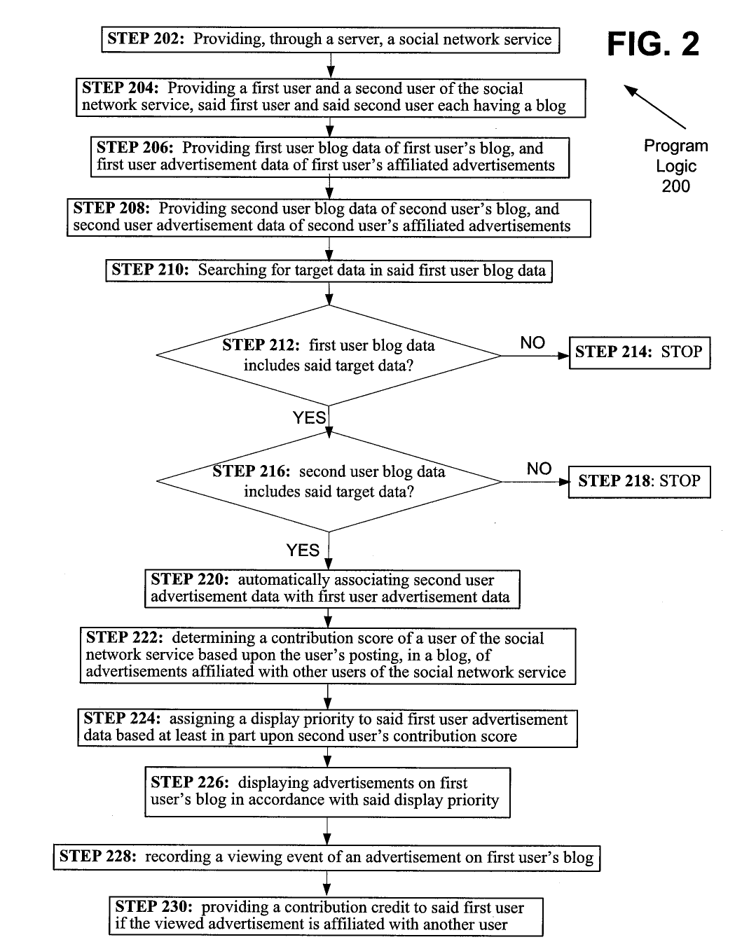

FIG. 2 is an exemplary flow diagram of an exemplary embodiment for a sequence of steps carried out by the system of FIG. 1. FIG. 2 illustrates an embodiment of program logic 200 as described below.

Step 202 includes providing, through a server, a social network. A social network may be any network or service or online meeting place that allows users to interact, meet, chat, exchange information, etc. Examples of such a social network may include, but are not limited to, Facebook, MySpace, LinkedIn, Friendster, Nexopia, Bebo, Hi5, Tagged, Xing, Skyrock, Orkut, Habbo, Flixster, Reunion, Classmates, and Netlog. The social network may allow users to link and associate with other users, i.e., become “friends,” to communicate and share common interests and/or activities. The social network may provide various capabilities to the user, such as blogging and real-time chatting.

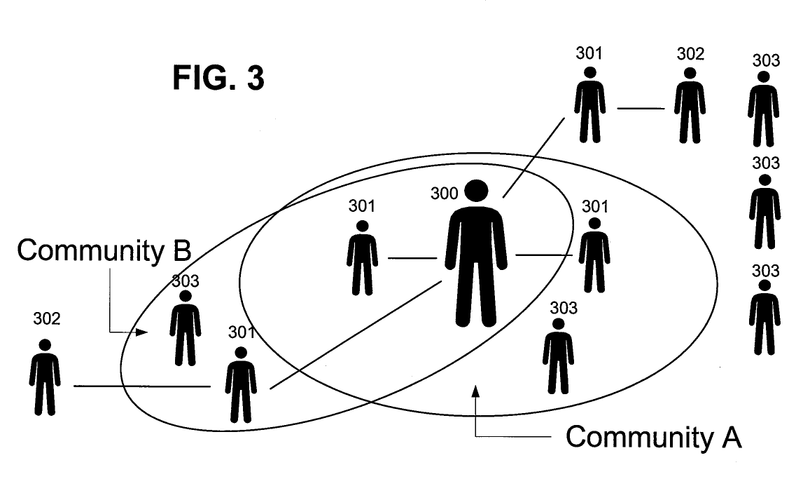

FIG. 3 discloses an exemplary social network. In FIG. 3, first user 300 has numerous acquaintances, including four “first friends” 301 with whom first user 300 is directly connected. Users may become first friends by, for example, sending and accepting requests to be linked to other users. The social network service may also allow other users to view a user's list of first friends. First user 300 is also indirectly connected to two “second friends” 302, who are “friends” with the first user's first friends 301. First user 300 may also join communities as part of the social network. These communities may be any group that links users, such as through a common interest, hobby, college, city, etc., and may include any of first user's first friends 301 or second friends 302, or may include other users who are “community friends” 303 with first user 300, i.e., users who are not directly or indirectly connected to first user 300 outside of the community. In FIG. 3, first user 300 is a member of two communities, Community A and Community B. As an example, Community A may be related to gardening, while Community B may be related to New York City.

Step 204 includes providing a first user and a second user of the social network, the first user and the second user each having a blog.

The second user of the social network may be determined by the social network service or by the first user, such as by prioritizing first user's acquaintances. For example, first user may prioritize acquaintances as follows: (1) first friends, (2) second friends, (3) community friends, and (4) other users in the social network. As an alternative example, first user may prioritize acquaintances as follows: (1) first friends in the same community, (2) first friends not in the same community, (3) second friends in the same community, (4) second friends not in the same community, (5) other users in the social network. These are non-limiting examples of such a prioritization, which can be accomplished in any way designated by the first user or the social network service.

The blog may be associated with the social network or may be external to the social network. A “blog” is also known as, and can be referred to as, blogging, web-log, weblogging, or diary. Examples of types of blogs may include artblogs (relating to art), photoblogs (relating to images and photographs), sketchblogs (relating to sketches), vblogs or videoblogs or vidblogs (relating to video), MP3 blogs (relating to music), and audioblogs (relating to podcasting). A blog can comprise any bit of media by which a user or users post data of any sort.

Step 206 includes providing first user blog data of first user's blog, and first user advertisement data of first user's affiliated advertisements.

Blog data can be any content of a shared on-line journal, electronic bulletin board, electronic forum, blog space, blogosphere, or communication space where a user or users can post information or data. Blog data may include any data that a user or users can post in a blog, and comprise very broad types of data. Non-limiting examples of such blog data include a user's or users' personal or public diary entries, personal or public journal, commentary, thoughts, opinions, experiences, hobbies, news, descriptions of events, subject-specific data and/or information, advertising information, advertisements, product identification, information or specification(s), service identification, information or specification(s), scientific and technical data, non-technical data, text, images, links, links to other blogs, links to web pages, links to articles, graphics, video, music, MP3 or other data files, media related to a topic or data, metadata, blog files, or network data. The scope of blog data also includes any data having any format that is within the nature of a blog posting or entry, or that is associated with a blog posting or entry and is part of the content, records, data, or metadata of a blog. Blog data may include previously-entered data or real-time data that is actively entered by one or more users. A blog can receive input from one or more users and/or sources. There is no limitation as to number, type, or sequence of user(s) and posters of blog post data. Any blog form is intended to be searched by the embodiments disclosed herein. Blog post data may be intended for general public viewing, viewing within a social network, or select or limited viewing. A “blogger” can be a contributor of blog post data, and may include a user or an artificial entity, such as an electronic-based actor, artificial intelligence, program, or other agent. In some embodiments, a blog post may require the review or approval of a blog forum controller or webmaster. The nature of the blog post data entry is not intended to be limited.

A user of the social network may become “affiliated” with an advertisement by, for example, selecting and displaying a “recommendation” or a “favorite” product or service, whereby a link to an advertisement related to the product or service is registered with the social network. The social network may also extract, retrieve, and store advertisements displayed on a user's blog, the blog being either part of the social network or external to the social network service. These examples are non-limiting; the advertisement may become “affiliated” with the user by any number of means.

Step 208 includes providing second user blog data of second user's blog, and advertisement data of second user's affiliated advertisements. Second user blog data and second user advertisement data may include any feature discussed above in relation to Step 204.

Step 210 includes searching for target data in the first user blog data. The term “target data” is intended to be construed very broadly and may comprise any data sought in a search, any data desired to be found, or any data, information, or blog data that can be searched for. Target data may also include any data associated with, related to, or deemed to assist in searching for a particular data or information. The target data may be specified and searched by a user or by the social network using any known data searching, matching, inputting, or other related program or service. Further, as stated above, a user's blog may be external to the social network, so the social network may correspond with other networks or programs to search for said target data.

Step 212 includes determining whether the first user blog data includes the target data. The target data may be an exact match to the blog data, or it may be any data that are part of a blog post or blog data, associated with blog data, related to blog data, derived from blog data, or otherwise intended to result in a positive match to blog data. This step may be accomplished using any known or relevant data matching or data comparison program, or any known data matching or data comparison method. The user may provide the data-matching rule or rules as to the target data sought and the method by which target data is evaluated. The user can set at least one parameter or variable for the search, using as broad or as narrow a tolerance as desired to maximize or minimize the amount and type of matches. The variables for the data-matching rules may include tags, categories, or keywords, any of which may be user-defined or defined by the blog program. The user or the blog program may set “tags” in the blog data. If the first user blog data does not include the target data, the sequence stops, as designated by Step 214. If the first user blog data includes the target data, the sequence continues with Step 216.

Step 216 includes, if the first user blog data includes the target data, determining whether the second user blog data includes the target data. This step may include any feature discussed above in relation to Steps 210 and 212. If the second user blog data does not include the target data, the sequence stops, as designated by Step 218. If the second user blog data includes the target data, the sequence continues with Step 220.

Step 220 includes, if the second user data includes the target data, automatically associating the second user advertisement data with the first user advertisement data. The second user advertisement data and the affiliation status of the second user's affiliated advertisements may be extracted and linked to and/or included in the first user advertisement data. Thus, the first user advertisement data may include data related to advertisements affiliated with the first user, as well as advertisement data affiliated with other users. If the user data is associated with an external blog, a WebAPI (web application programming interface) may be used to extract related affiliate advertisements from a user's or users' external blogs. One example of WebAPI is a REST (Representational State Transfer)-based API, which is generally used in an AJAX system. Using a REST-based API, a web page is easily integrated with other web systems, advertisements from external web sites can be requested, and affiliate links can be dynamically displayed in the website. In one embodiment, variables, tags, and other user information variables can be associated with the rule.

Step 222 includes determining a contribution score of a user based upon the user's posting, in a blog, of advertisements affiliated with other users. As stated above, first user advertisement data may include data related to advertisements affiliated with the first user, as well as advertisement data affiliated with other users. A user may “contribute” to another user by posting blog advertisements that are affiliated with another user. In exchange for posting these advertisements, the user may receive a contribution point or points through the social network when a reader “clicks” on an advertisement affiliated with another user, or when the clicked advertisement links the reader to a purchasing website from which a product is then purchased. The user may also receive a contribution point or points through other ways and means.

The user's contribution score may be determined based at least in part upon the user's contribution points. A user's contribution score may be determined in terms of the user's contribution to another user and/or the user's net contribution over the social network. For example, second user's contribution score may depend on second user's individual contributions to first user (i.e., posting advertisements affiliated with the first user). Alternatively, second user's contribution score may be the net contribution to other users (such as the sum of second user's contribution to first user, third user, etc., by posting advertisements affiliated with these users). As discussed in greater detail below, in exchange for posting by proxy another user's affiliated advertisement, the second user may receive contribution point(s), which may result in the second user's affiliated advertisements being more likely to be displayed by proxy in another user's blog. Such an exchange of benefits may increase the mutual posting of advertisements among users.

Step 224 includes assigning a display priority to the first user advertisement data based at least in part upon the second user's contribution score. The display priority hierarchy may be determined in any number of ways. The order of priority for the display of advertisements in first user's blog post may be, e.g., (1) affiliated advertisement of a “first friend” of the first user, (2) affiliated advertisement that satisfies condition (1) and has contents most similar to the contents of first user's blog post, (3) advertisement affiliated with another user who previously contributed to the first user's sales by posting an advertisement affiliated with first user; and (4) advertisements used in the social network that are the most similar to the contents of the first user's blog post. The display priority scheme may also consider each user's individual or net contribution score, such as by considering second user's contribution to first user as an individual, and/or second user's net contribution to other users. The first user's blog may include an advertisement that is affiliated with a user who is not a “friend,” “community friend,” or otherwise acquainted with the first user if there is a determination that a new “connection” or “friendship” can derive from the first user posting the affiliated advertisement. Such a mechanism may contribute to the expansion of the social network. The display priority may also include advertisements that are affiliated with the first user and not with other users. The first user's blog may display by proxy an advertisement that has been extracted from second user's advertisement data such that first user may contribute to second user. If an extracted and displayed advertisement is affiliated with a number of users, higher priority should be given based upon the users' contribution scores. For example, if ten users have the same affiliated advertisement, the displayed advertisement should be attributed to the user with the highest contribution score.

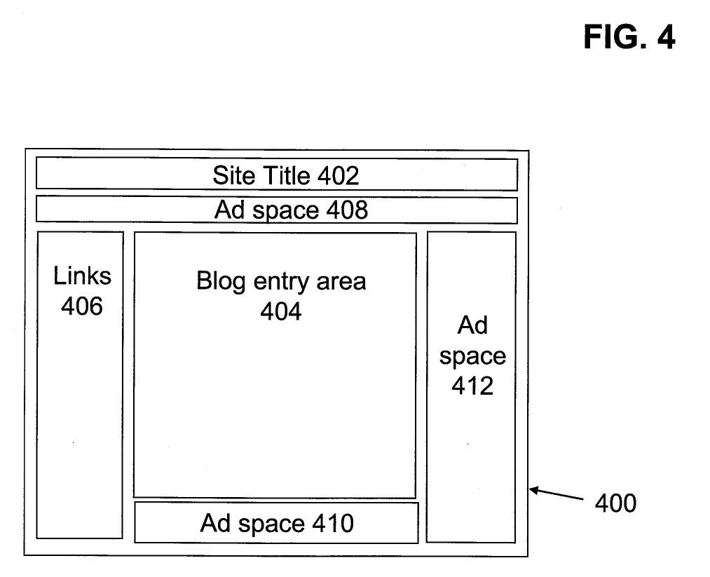

Step 226 includes displaying the first user advertisement data in accordance with the display priority. The advertisements associated with the display priority scheme determined in Step 224 may be displayed in accordance with the page structure of the first user's blog page. For example, the blog page may have a blog page structure similar to the structure in FIG. 4. Blog page 400 may include site title 402 at the top of the page, blog entry area 404 in the middle of the page, advertisement space 408 above the blog entry area 404, advertisement space 410 below the blog entry area 404, and advertisement space 412 to the left or the right of the blog entry area 404. The display priority scheme may determine the hierarchy of advertisement placement; for example, a single advertisement with the highest priority may be in advertisement space 408, a single advertisement with the second highest priority may be in advertisement space 410, and a number advertisements, starting with the advertisement with the third highest priority, may be listed vertically by priority in advertisement space 412.

Step 228 includes recording a viewing event of an advertisement on first user's blog. One example of a viewing event includes selecting or clicking an advertisement on the first user's blog (also known as “click count”), whether it just for viewing the advertisement or for purchasing a product through the advertisement. The viewing event may be recorded using any known means for recording the event, such as the memory disclosed in FIG. 1. The viewing event may be conducted by a user of the social network service or any other reader of the first user's blog.

Step 230 includes providing a contribution credit to the first user if the viewed advertisement is affiliated with another user. The contribution credit may be determined based upon the number of views of the advertisement (the “click count”), product sales via clicked advertisements, price of the viewed advertisements, etc. As stated above, contribution credits may be determined in any number of ways, either alone or combined. The various methods of determining contribution credit may be weighed differently, such as by assigning higher credits to resultant product sales. The criteria for providing a contribution credit should be defined in the system.

Although specific example embodiments have been disclosed, a person skilled in the art will understand that changes can be made to the specific example embodiments without departing from the spirit and scope of the invention.

What is claimed is:

1. A method, comprising:
providing, through a server, a social network service;
providing a first user and a second user of the social network service, said first user and said second user each having a blog;
providing first user blog data of first user's blog, and first user advertisement data of first user's affiliated advertisements;
providing second user blog data of second user's blog, and second user advertisement data of second user's affiliated advertisements;
searching for target data in said first user blog data;
determining whether said first user blog data includes said target data;
if said first user blog data includes said target data, determining whether said second user blog data includes said target data;
if said second user blog data includes said target data, automatically associating said second user advertisement data with said first user advertisement data;
determining a contribution score of a user of the social network service based upon the user's posting, in a blog, of advertisements affiliated with other users of the social network service;
assigning a display priority to said first user advertisement data based at least in part upon second user's contribution score;
displaying advertisements on first user's blog in accordance with said display priority;
recording a viewing event of an advertisement on first user's blog; and
providing a contribution credit to said first user if the viewed advertisement is affiliated with another user.
